(19) United States
(12) Patent Application Publication
(10) Pub. No.: US 2012/0218417 A1
(43) Pub. Date: Aug. 30, 2012

(54) SHORT THROW RATIO FLUORESCENT COLOR VIDEO DISPLAY DEVICE

(75) Inventors: Donald Paul Bilger, Livonia, MI (US); Mahendra Somasara Dassanayake, Bloomfield Hills, MI (US)

(73) Assignee: FORD GLOBAL TECHNOLOGIES, LLC, DEARBORN, MI (US)

(21) Appl. No.: 13/036,008

(22) Filed: Feb. 28, 2011

(51) Int. Cl. H04N 5/33; G03B 21/28; G03B 21/14

(52) U.S. Cl. 348/164; 353/84; 348/E05.09

(57) ABSTRACT

A short throw ratio projection display system that produces high-resolution and high-dynamic range images. The system comprising a scanning laser for generating a light beam optically modulated with image information. The system further includes an image plane, in light of sight of the light beam, the image plane coated with an image-enhancing layer on a first side and a layer of fluorescent material strips on a second side. The image plane generates an image corresponding to the image information by absorbing the light beam and emitting visible fluorescent light corresponding to the intensity of the light beam falling on the fluorescent material.

### BACKGROUND

This application relates generally to display devices, and more particularly to projection screens.

There are several technologies in use today for color video displays, such as cathode ray tubes (CRTs), Liquid crystal displays (LCDs), plasmas, and front projectors. CRTs offer good brightness, contrast, and motion rendition, but they are large and bulky, requiring significant package depth. LCDs offer good brightness and contrast in a compact, lightweight package, but they provide poorer image quality at off-axis viewing angles than a CRT. Moreover, LCDs may have difficulty rendering fast motion without visible artifacts. Plasma displays offer good contrast, motion rendition and off-axis performance in a thin package, but they cannot match the brightness of a good CRT or LCD display, and they generally cost more than LCD displays of comparable size. Front projectors, which use a separate projector and screen, offer high performance, but they are generally best suited to use in a darkened room, and they can be inconvenient to install.

Another display technology that is advancing in the recent decades is rear projection systems. These systems, which look more like traditional televisions, display images on the back of a screen rather than the front and contain the projector completely within the television itself. Rear projection systems typically offer high performance and are suitable for a well-lit room, as the light source projects images within the television set. These displays, however, suffer because of high throw ratios. Throw ratio refers to the ratio of the distance to the screen (throw) to the screen diagonal. This ratio affects the distance from the projector to the screen for a particular screen size. The higher the throw ratio, the further the projector must be placed from the screen. Typical projection systems (rear and front) have a large throw ratio, which prevents viewing a large screen in a small room. Moreover, for rear projection televisions, if the throw ratio is too large, the projector may be placed further from the screen, which makes the television too bulky, preventing users from mounting the television on a wall. Alternatively, to reduce the depth of the television, the screen size may be reduced, which again reduces viewing pleasure.

As none of the prior art systems provide high performance regarding throw ratio, contrast ratio, dynamic ratio, and screen size, there exists a need for a system that provides a short throw ratio, high contrast ratio, high dynamic ratio display device.

### SUMMARY

One embodiment of the present application describes a short throw ratio display system that produces high-resolution, high-dynamic range images. The system includes a scanning laser for generating an optically modulated light beam corresponding to image information. The system further includes an image plane, which is in line-of-sight of the light beam. The image plane may be coated with an image-enhancing layer on a first side and a layer of fluorescent material strips on a second side. The image plane generates an image corresponding to the image information by absorbing the light beam incident on the fluorescent material and emitting visible light corresponding to the intensity of the incident light beam.

Another embodiment of the present disclosure describes a projection-type display system including a scanning laser for generating an optically modulated light beam that carries image information, and an image plane coated with fluorescent material for producing an image corresponding to the image information by absorbing the optically modulated light beam and emitting visible fluorescent light. The system further includes a reflective mirror assembly for reflecting the modulated light beam from the scanning laser to the image plane, and a projection lens for projecting the image produced by the image plane. The system further includes a screen for displaying the image projected by the projection lens.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates a typical projection system.

FIG. 2 illustrates an exemplary system for projecting an image according to embodiments of the present invention.

FIG. 3 illustrates exemplary sub-pixel structures according to embodiments of the present invention.

FIG. 4 is a plan view of an exemplary micro-mirror according to embodiments of the present invention.

FIG. 5 is an elevation view of an exemplary micro-mirror according to embodiments of the present invention.

FIG. 6 illustrates an exemplary system for direct viewing an image according to embodiments of the present invention.

FIG. 7 illustrates an exemplary sub-pixel structure according to embodiments of the present invention.

FIG. 8 illustrates an exemplary sub-pixel structure according to embodiments of the present invention.

### DETAILED DESCRIPTION

The following detailed description is made with reference to the figures. Exemplary embodiments are described to illustrate the subject matter of the disclosure, not to limit its scope, which is defined by the appended claims.

### Overview

Embodiments of the present system offer short throw ratio, high-resolution, and high-contrast images on a projection screen using fluorescent dyes. Depending on the implementation, the system described here may also have a package depth nearly as small as a plasma or LCD display. In one embodiment, a flat screen is coated on its front (viewing) side with a contrast-enhancing layer that prevents light from passing through from the front to the back. The back side is coated with a series of fine-pitch vertical stripes. These stripes contain fast-responding fluorescent dyes in each of the three primary light colors (red, green and blue). Alternate fluorescent dye patterns are also possible and would resemble the RGB phosphor dot patterns used on various brands of color CRTs.

To generate an image, a scanning laser is optically modulated with RGB video data (image information) and it directs the modulated beam in a raster pattern to the fluorescent screen. The fluorescent material absorbs the incident beam and emits light, illuminating the dye stripes from the rear in a raster pattern. Since the light is emitted from the fluorescent dye rather than from the laser, a single laser of any desired color may be used to pump energy into the dye stripes. The raster pattern may be interleaved or non-interleaved. The output level of the laser as it sequentially illuminates the red, green and blue stripes at each pixel position determines the luminance and chroma values for that pixel.

Multiple lasers may be used if desired, with or without a shadow mask, to support higher refresh rates than a single laser can support. Moreover, the optical path from the laser to the screen may be folded using lenses, mirrors, or a combination of both to reduce the depth of the display system.

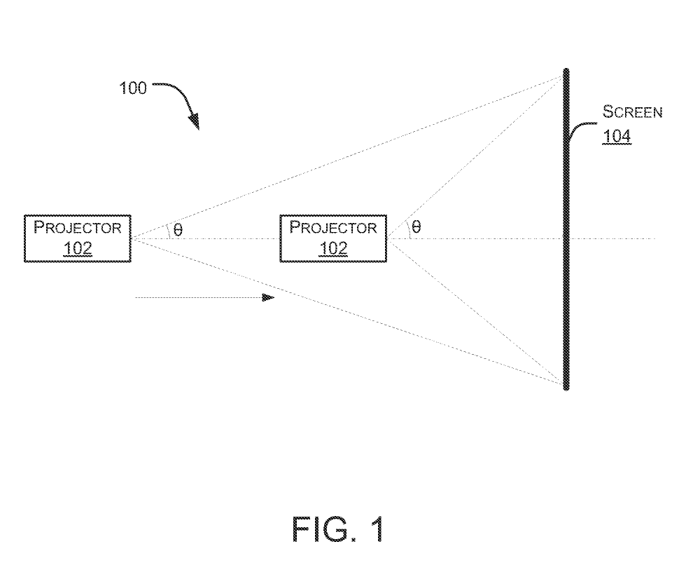

Obtaining a short throw ratio is a difficult task in typical phosphor coated displays. One problem faced while achieving a short throw ratio in typical displays is reduction in image brightness. FIG. 1 illustrates this problem utilizing a typical projection system 100 including a projector 102 and a screen 104. When the projector 102 is brought closer to the screen 104, the solid angle θ extending from the projector 102 to the screen 104 increases as depicted in FIG. 1. The projector light beam has to expand over a greater area in a shorter distance. Moreover, the brightness of an image is dictated by the formula:

$$Brightness = \frac{Amount of Energy falling on the Screen}{Area of the Laser \times Solid Angle of the Light Emission ( θ )}$$

So, when the projector 102 is brought closer to the screen 104 (in order to reduce the throw ratio), the solid angle θ of light emission increases, which reduces the brightness of the screen. By incorporating fluorescent dyes, this problem can be overcome. Fluorescent dyes emit their own light by absorbing incident light and this light emission depends merely on the amount of energy falling on the dye. So, the more the light falls on the dye, the more the dye emits.

This system does not require high vacuum or a high-voltage anode power supply to deliver a bright, high-contrast, high-resolution video image. It offers higher contrast, faster response time, and a larger viewing angle image as compared to an LCD. It also offers higher brightness than a typical plasma display. Moreover, in comparison to typical projection-type displays, embodiments of the system disclosed here offer a much shorter throw ratio.

### EXEMPLARY EMBODIMENTS

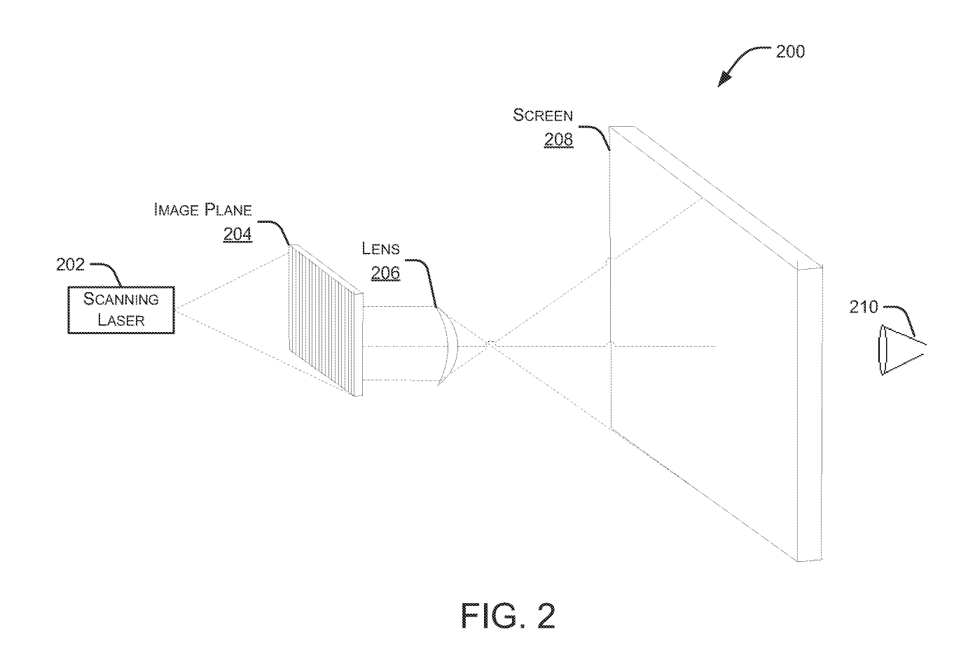

FIG. 2 illustrates an exemplary projection system 200 according to embodiments of the present invention. The projection system 200 described here may be utilized in hand-held projectors, rear projection televisions, or front projection projectors. It will be understood that the applications of this projection system 200 are not limited by the examples set out above, and this system may be utilized for any other known applications, such as in-vehicle display systems, etc. The system 200 includes a scanning laser 202 (or “laser” or monochromatic laser”), an image plane 204, a projection lens 206, and a screen 208, which may be viewed by a viewer 210.

A digital image signal may modulate the light emitted by the scanning laser 202. Various optical modulation techniques are known in the art and any of those techniques may be utilized here to modulate the optical beam without departing from the scope of the present invention. The modulated light beam is incident on the image plane 204, creating a high quality, small image on the image plane 204. This image is then focused and enlarged using one or more projection lens 206 and displayed on the screen 208. The screen 208 may be a projector screen, a wall, or a television screen without departing from the scope of the present invention. It will be understood that depending on the type of display—front projection or rear projection, the viewer 210 location may vary.

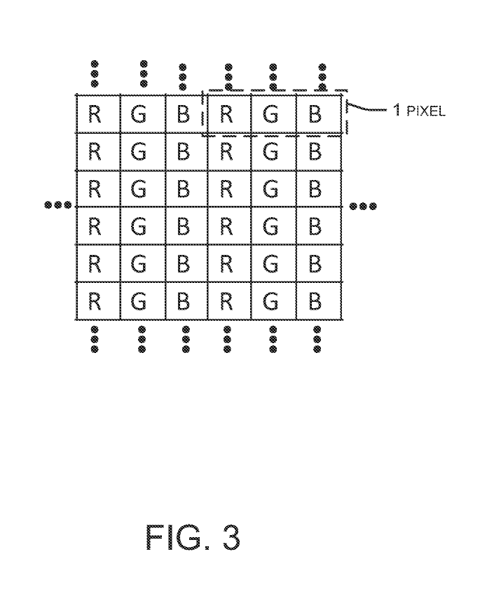

The screen 208 includes a contrast-enhancing layer on the front side 212 that prevents light from passing through from the front side 112 to the rear side 214. The rear 214 is coated with fluorescent material, such as RGB fluorescent dyes. The dyes may be coated in numerous vertical stripes, which correspond to the horizontal screen resolution (as shown in FIG. 3). Each RGB triplet of strips represents one horizontal pixel. So, a high resolution display might have 1920 vertical RGB triplet stripes. It will be understood that depending on the resolution required, the number of vertical stripes may vary.

The vertical resolution of the screen is a function of the raster pitch, since the fluorescent stripes run continuously from top to bottom of the image plane 204. For example, for a high resolution display, the vertical resolution may be 1080 horizontal scans per image.

When the incident light beam from the scanning laser 202 falls on the fluorescent dyes, the dyes absorb the scanning beam and emit light of a particular wavelength (red, blue or green) depending on the dye type. Intensity and color variation of the different sub-pixels scanned by the laser creates an image on the image plane 204 corresponding to the initial digital image signal. The laser beam carries image information, but does not directly produce the visible light seen by the viewer 210. Instead, the color light-emitting fluorescent dyes on the image plane 204 absorb the energy and emit visible light in red, green and blue to generate actual color images seen by the viewer 210.

Because the fluorescent dyes determine the brightness and color variation of the image, a monochromatic laser is sufficient to light up the image plane 204. Depending on the particular application, the monochromatic laser 202 can produce a single beam of a particular wavelength, such as visible color, UV, or other wavelengths.

Fluorescent dyes have a number of advantages over their conventional phosphor counterparts. For instance, fluorescent dye particles are two orders of magnitude smaller than the phosphor particles, providing a higher resolution than typical phosphor coated displays. Moreover, dye particles emit light more efficiently than the phosphor particles. Because phosphor is in triplicate stage (emitting light in three excited levels after being pumped with energy), it emits light after an approximate lag of a few nanoseconds. Whereas a fluorescent dye is a single stage material (emitting light immediately after being pumped with energy) producing a lag of just a few picoseconds, making dye particle emission much faster than phosphor particle emission. Further, using fluorescent dyes, brightness is created within the image plane 204, which allows expansion of the laser solid angle, thereby efficiently achieving a shorter throw ratio.

Fluorescent dyes also increase the dynamic range of an image. The laser beam can be modulated by the RGB signal. In one embodiment, the laser beam may be pulse-width modulated. Alternatively, the laser beam may be pulse amplitude modulated. The power of the laser 202 defines color depth of the fluorescent pixels. Depending on the amount of energy incident on a pixel, the pixel light intensity varies. Prolonged or high intensity incident energy can produce more intense colors than shorter or low intensity incident light. Therefore, higher dynamic range and higher contrast may be obtained.

The scanning laser 202 may impart energy to the image plane in a raster fashion. The laser may scan the image plane in an interleaved or non-interleaved fashion depending on the implementation. In other embodiments, multiple lasers may be utilized to impart energy on the image plane 204. For example, different lasers may scan different sections of the image plane 204. Alternatively, one laser may scan one interleaved plane, while a second laser may scan the second interleaved plane. It will be understood that other methods for scanning the display as used in the art presently or in the future may be utilized without departing from the scope of the present invention.

The optical path from the scanning laser 202 to the image plane 204 may be folded using mirrors or lenses so that the depth of the projection television may be reduced. A number of optical path folding techniques that utilize mirrors or lenses are known in the art and the system 200 described here may utilize any of those techniques to fold the optical path and reflect the light beam from the laser 202 to the image plane 204 without departing from the scope of the present invention.

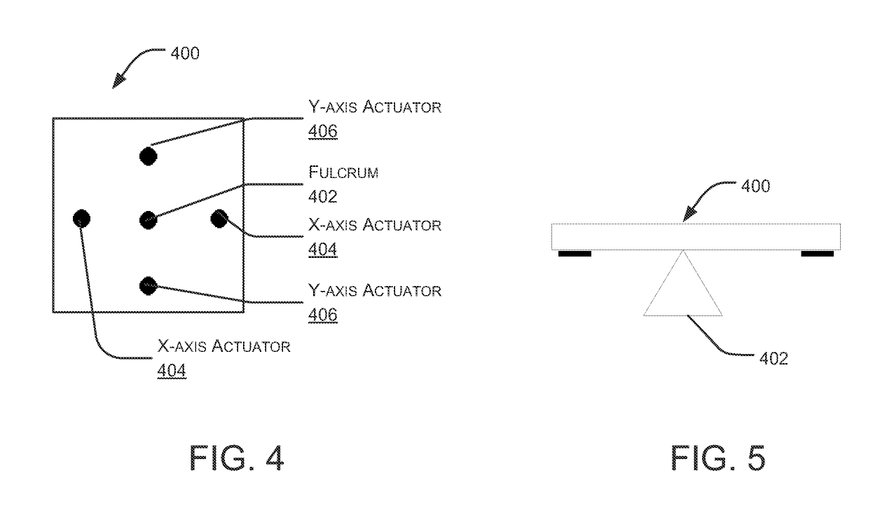

In addition to those techniques, the laser light beam may be reflected using a microelectromechanical system (MEMS) such as a micro-mirror controlled by piezoelectric or electrostatic elements. FIGS. 4-5 illustrate one such micro-mirror 400. The mirror 400 may be centrally mounted on a fulcrum 402 as shown in FIG. 5. The mirror 400 may also have piezoelectric or electrostatic elements, such as X-axis actuators 404 and Y-axis actuators 406 mounted on the bottom of the mirror 400. FIG. 5 is a side-view of the micro-mirror 400 displaying the X-axis actuators 404. A piezoelectric element such as a quartz crystal or an electrostatic element such as a charged capacitor may be used to scan the image. By varying the amount of current/voltage supplied to the actuator elements 404, the mirror 400 may be displaced in any suitable direction. Here, the scanning laser 202 can be stationary or moved slightly, while the major movement is produced by the micro-mirror 400 in such as way as to produce a scanning beam. Electricity may be supplied to actuators, deforming them or charging them in such as way as to move the reflective mirror 400 from left to right and top to bottom.

By displacing the normal of the reflective mirror 400 a certain distance, the reflected beam is displaced two times the moved distance. Therefore, the laser 202 and the mirror 400 may be incrementally moved by really small values and the micro-mirror 400 itself can be very small, reducing the power required to operate the projection system 200 and reducing the projector packaging depth further. Moreover, if the projection system 200 is mounted in a vehicle, due to the small size of the projection components, the system would barely be affected by motion vibration.

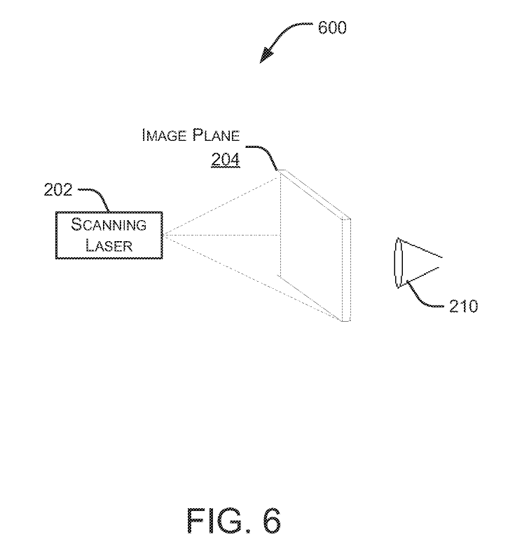

FIG. 6 illustrates a direct view type display system 600. Here, the scanning laser 202 directly scans the rear of the image plane 204. The viewer 210 is present on the front of the image plane 204, from where the user may view the image/video. As described with relation to projection-type displays, the optical beam from the laser 202 to the image plane 204 may be reflected off a mirror assembly in this display system as well according to the techniques described previously.

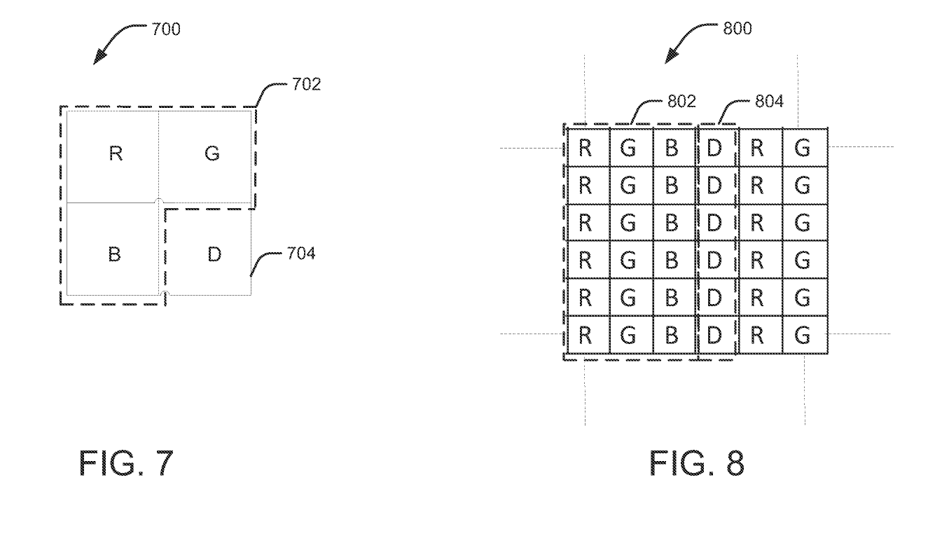

The pixel clusters in the direct view type display systems 600 may be modified to include a 4^{th} sub-pixel in a pixel. This fourth sub-pixel may be a detector pixel. FIGS. 7 and 8 illustrate two different pixel arrangements for the four sub-pixel pixel. FIG. 7 illustrates a 2×2 array 700 composed of the three RGB sub-pixels 702 and a detector sub-pixel 704, while FIG. 8 illustrates a 1×4 array 800 of the RGB sub-pixels 802 and a detector sub-pixel 804 making up one pixel. In the second arrangement, when pixels are arranged one on top of the other to form the complete screen, the RGB 802 and detector sub-pixels 804 form vertical stripes, which can be easily deposited on the image plane 204.

The fourth sub-pixel i.e. the detector pixel 804 may have numerous applications. For example, in one embodiment, the detector pixel 804 may be an infrared sensor pixel providing touch screen capabilities to the projection system. By using a video camera behind the screen to detect which portions of the screen are being touched, and by mapping these touches to a fixed or variable look-up table defining what actions the system should take for a given touch, the infrared sensor can convert the simple display into an interactive television or display device. In vehicles, this display device may be utilized as a GPS, a touch screen gaming console, or an interactive entertainment display (such as those installed in most airplanes). Moreover, these touch screen display devices may be used in point of sale terminals, mobile phone displays, and so on.

Alternatively, the fourth pixel might be a charge coupled device (CCD) sensor or a complementary metal oxide semiconductor (CMOS) image sensing pixel. Use of an image sensor pixel as the fourth pixel converts the display into a camera-cum-display device. This type of device may be utilized to conduct two-way video conferences, and other such applications.

These detector pixels may be connected to image converting and analyzing hardware (not shown) or processors inside the display device. Any image or touch sensed by the sensors is converted into electrical signals and transmitted to the processors. The processors in turn may convert the signal into digital data and further process that signal to obtain an image or analyze the received electrical signal to determine which portion of the screen was touched and which command corresponds to that portion of the screen (such as volume control, power switch, or an interactive menu).

As the detector pixel is in the same line of sight as the other RGB sub pixels, it is important to modulate the digital image data such that the laser is off when its light beam travels over the detector pixel so that it does not impart any light on the detector pixel, which might destroy the sensor.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A short throw ratio display system for producing high-resolution and high-dynamic range images, the system comprising:
a scanning laser for generating an optically modulated light beam; and
an image plane, in line of sight of the light beam for generating an image, the image plane being coated with an image-enhancing layer on a first side and a fluorescent material layer on a second side, the fluorescent material layer being coated in numerous vertical stripes and being capable of absorbing the modulated light beam and generating the image.

2. The system of claim 1, wherein the system is a direct view type display.

3. The system of claim 1, wherein the system is at least one of a rear-projection-type display, or a front projection-type display.

4. The system of claim 3 further comprising a projection lens for transmitting and enlarging the image generated by the image plane.

5. The system of claim 4 further comprising a screen for displaying the image projected by the projection lens.

6. The system of claim 3 further comprising a micro-mirror for reflecting and folding the light beam from the scanning laser to the image plane.

7. The system of claim 6, further comprising at least one of piezoelectric or electrostatic element for positioning the micro-mirror such that the reflected beam from the micro-mirror scans the image plane.

8. The system of claim 1, wherein the fluorescent material layer includes multiple pixels, each pixel comprising:
a red sub-pixel,
a green sub-pixel, and
a blue sub-pixel.

9. The system of claim 1, wherein the image plane comprises multiple pixels, each pixel comprising:
a red sub-pixel,
a green sub-pixel,
a blue sub-pixel, and
a detector pixel.

10. The system of claim 9, wherein the detector pixel includes at least one of an infrared sensor, a charge coupled device (CCD) image sensor, or complementary metal oxide semiconductor (CMOS) image sensor.

11. The system of claim 10 further comprising a processor for processing signals sensed by the infrared sensor, the CCD image sensor, or the CMOS image sensor.

12. A projection-type display system comprising:
a scanning laser for generating an optically modulated light beam that carries image information;
an image plane coated with fluorescent material for producing an image corresponding to the image information by absorbing the optically modulated light beam and emitting visible fluorescent light;
a mirror assembly for reflecting the modulated light beam from the scanning laser to the image plane;
a projection lens for projecting the image produced by the image plane; and
a screen for displaying the image projected by the projection lens.

13. The projection-type display system of claim 12, further comprising an optical modulation system to modulate the light beam according to the image information.

14. The projection-type display system of claim 12, wherein the image plane comprises multiple pixels.

15. The projection-type display system of claim 14, wherein the pixels comprises:
a red fluorescent sub pixel,
a green fluorescent sub pixel, and
a blue fluorescent sub-pixel.

16. The projection-type display system of claim 15, wherein the pixels further comprises a detector sensor pixel.

17. The projection-type display system of claim 16, wherein the detector pixel is at least one of:
an infrared sensor,
a charge coupled device (CCD) image sensor, or complementary metal oxide semiconductor (CMOS) image sensor.

18. The projection-type display system of claim 17 further comprising a processor for processing signals captured by the infrared sensor, the CCD image sensor, or the CMOS image sensor.

19. The projection-type display system of claim 12, wherein the mirror assembly is controlled by at least one of a piezoelectric or an electrostatic actuator.
